(19) United States
(12) Patent Application Publication
(10) Pub. No.: US 2012/0137846 A1
(43) Pub. Date: Jun. 7, 2012

(54) CUTTING BY MEANS OF A JET OF LIQUID CRYOGENIC FLUID WITH ADDED ABRASIVE PARTICLES

(75) Inventors: Jacques Quintard, Presles (FR); Frédéric Richard, Parmain (FR); Charles Truchot, Poissy (FR)

(73) Assignee: L' Air Liquide Societe Anonyme pour l'Etude et l'Exploitation des Procedes Georges Claude, Paris (FR)

(21) Appl. No.: 13/383,020

(22) PCT Filed: Jun. 1, 2010
(86) PCT No.: PCT/FR2010/051058

§ 371 Date: Jan. 9, 2012

(30) Foreign Application Priority Data
Jul. 9, 2009 (FR) 0954745

(51) Int. Cl. B26F 3/00

(52) U.S. Cl. 83/13; 83/177

(57) ABSTRACT

The invention relates to a process and device for cutting materials, such as metals, concrete, wood, plastics or any other type of material, by means of a jet of cryogenic fluid at very high pressure with added abrasive, in particular corundum. Materials can be cut using a disk cutter (concrete, stone, metals, etc.), with a saw (metals, wood, plastics, etc.), by laser beam (metals, plastics, etc.), using a plasma jet (metals), using an ultrahigh pressure (UHP) water jet with or without abrasives (any type of material).

### CROSS REFERENCE TO RELATED APPLICATIONS

This application is a 371 of International PCT Application PCT/FR2010/051058, filed Jun. 1, 2010, which claims priority to French Application 0954745, filed Jul. 9, 2009, the entire contents of which are incorporated herein by reference.

### BACKGROUND

The invention relates to a process and device for cutting materials, such as metals, concrete, wood, plastics or any other type of material, by means of a jet of cryogenic fluid at very high pressure with added abrasive, in particular corundum.

Materials can be cut using a disk cutter (concrete, stone, metals, etc.), with a saw (metals, wood, plastics, etc.), by laser beam (metals, plastics, etc.), using a plasma jet (metals), using an ultrahigh pressure (UHP) water jet with or without abrasives (any type of material), etc.

However, when there must be no hot spot in contact with hard materials, during the cutting process, only cutting with an UHP water jet with abrasive is used. In this case, according to a quite widespread cutting process, water at a pressure (UHP) between 1000 and 4000 bar is brought to a mixing chamber made of stainless steel, into which a stream of compressed air transporting an abrasive of garnet or olivine type is simultaneously introduced so as to form a mixture of water and of abrasive at ultrahigh pressure. This water/abrasive mixture is then conveyed in the direction of the material to be cut by a focusing gun made of tungsten carbide, such as that represented in FIG. 1.

Thus, FIG. 1 schematically shows a conventional structure of a focusing gun 5 made of tungsten carbide used for conveying an abrasive material to a material to be cut. This focusing gun 5 comprises a first intake or inlet 1 through which the gun is supplied with an abrasive/compressed air mixture, a second intake or inlet 2 through which the gun 5 is supplied with water at UHP, for example between 1000-4000 bar, a head 3 of venturi type, a mixing chamber 4 and an outlet for the mixture formed of pressurized water with added abrasive.

However, in certain cases, the use of water is itself problematic. Indeed, the use of water for certain applications for cutting a contaminated part, for example following contamination with a chemical, nuclear radiation or others, has pollution risks and requires complex and expensive recovery systems.

One alternative solution to cutting with water is proposed by the use of cryogenic jets, as taught by document U.S. Pat. No. 7,310,955 for example. In this case, a cryogenic fluid, in general liquid nitrogen, under very high pressure is used as a replacement for water in order to carry out the desired cutting.

However, this process cannot be used for cutting certain hard materials such as metal, stone, concrete, etc., in particular when their thickness becomes too large, for example greater than around 10 mm.

Furthermore, it has been observed that the gun for distributing the cryogenic fluid, or even also the mixing chamber, of the cutting device may be very rapidly eroded when the fluid has added abrasive particles, in particular when the particles have a high hardness.

It follows that the problem which is faced is to be able to use a process and a device for cutting using a jet of UHP cryogenic fluid in order to cut various types of materials, including hard materials, such as concrete, metals, stone, wood, plastics, etc., and/or having thicknesses which may reach 10 cm, without exhibiting the aforementioned drawbacks.

### SUMMARY

The invention includes both methods and apparatus to achieve the desired results, as described, but is not limited to the various embodiments disclosed.

The solution of the invention is then a process for cutting a material, in which said material is cut by means of a cutting jet at a pressure of at least 100 bar, characterized in that:

the cutting jet is formed by mixing at least a first compound in liquid form and at a cryogenic temperature of less than −100° C., and solid abrasive particles formed from at least one abrasive material having a hardness index of at least 6 Mohs, the solid abrasive particles being contained in a gas stream, and

the cutting jet is pointed toward the material to be cut using a focusing gun supplied with said mixture, the material forming, completely or partially, the focusing gun having a hardness greater than the hardness of the solid abrasive particles used.

Depending on the case, the cutting process of the invention may comprise one or more of the following features:

the mixing of the liquid stream and the solid abrasive particles transported by the gas stream takes place in a mixing chamber;

the pressure of the cutting jet is between 500 and 4000 bar, between 1000 and 3800 bar, preferably of the order of 3000 to 3500 bar;

the compound in liquid form is at a temperature of less than −150° C., preferably between −160° C. and −230° C.;

the compound in liquid form is liquid nitrogen;

the solid abrasive particles comprise at least one abrasive material chosen from the group formed by corundum, garnet, tungsten carbide, silicon carbide, olivine, alumina and calcium carbonate;

the solid abrasive particles have a particle size between 20 and 200 mesh, preferably 60 and 100 mesh;

the solid abrasive particles are advantageously particles of corundum, garnet or olivine, advantageously corundum;

the material to be cut is made of metal, concrete, ceramic, wood, plastic, any other polymer or a hard organic material;

the material to be cut has a thickness between 1 cm and 20 cm, typically between 1 and 10 cm;

the cutting speed is between 0.01 and 4 m/min depending on the nature of the material to be cut;

the cutting jet comprising the compound in liquid form and the solid abrasive particles is obtained by mixing said compound in liquid form with an air stream comprising the solid abrasive particles;

the mixing of the liquid stream and the abrasive transported by a gas stream takes place in a mixing chamber formed, completely or partially, i.e. bulk part or internal surface coating, of hardened steel, of tungsten carbide, of silicon carbide, of titanium carbide or boron carbide, boron nitride, preferably cubic boron nitride, or of diamond, preferably of a material having a hardness greater than the hardness of the solid abrasive particles used;

the cutting jet is pointed toward the material to be cut by means of a focusing gun supplied with the mixture obtained in said mixing chamber;

the material forming, completely or partially, i.e. bulk part or internal surface coating, the focusing gun has a hardness greater than the hardness of the solid abrasive particles used when said particles are made of corundum;

the material forming, completely or partially, i.e. bulk part or internal surface coating, the focusing gun is tungsten carbide with a cobalt content between around 0.1 and 10%, preferably of the order of 0.15% to 0.5%, for example of the order of 0.25%, silicon carbide, titanium carbide, boron carbide, cubic boron nitride or diamond;

the mixing of the liquid stream and the abrasive transported by a gas stream takes place in a mixing chamber formed, completely or partially, of hardened steel, of tungsten carbide with a cobalt content between around 0.1 and 10%, of silicon carbide, of titanium carbide, of boron carbide, of cubic boron nitride or of diamond;

the mixing chamber or the gun is formed, at least partially, of tungsten carbide with a cobalt content between around 0.1 and 10%, and the tungsten carbide grains have a size of less than 1.5 μm, preferably between 0.1 and 0.6 μm.

The invention also relates to a device for cutting using a cutting jet at a pressure of at least 100 bar comprising a source of pressurized cryogenic liquid fluidly connected to a mixing chamber in order to supply said mixing chamber with pressurized cryogenic liquid, and a focusing gun fluidly connected to said mixing chamber, characterized in that it also comprises a source of abrasive particles having a hardness index of at least 6 Mohs, supplying the mixing chamber so as to supply the focusing gun with a mixture formed of pressurized cryogenic liquid and said abrasive particles, said mixture is delivered by the focusing gun in the form of a cutting jet, the focusing gun being formed, completely or partially, of tungsten carbide with a cobalt content between around 0.1 and 10%, of silicon carbide, of titanium carbide, of boron carbide, of cubic boron nitride or of diamond.

Depending on the case, the device of the invention may comprise one or more of the following features:

the mixing chamber is formed, completely or partially, of hardened steel, of tungsten carbide with a cobalt content between around 0.1 and 10%, of silicon carbide, of titanium carbide, of boron carbide, of cubic boron nitride or of diamond;

the focusing gun or the mixing chamber is formed, completely or partially, of tungsten carbide comprising a cobalt content between around 0.1 and 10%, the tungsten carbide grains having a size of less than 1.5 μm.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 schematically shows a conventional structure of a focusing gun (5) made of tungsten carbide used for conveying an abrasive material to a material to be cut.; and

FIG. 2 illustrates the structure of an embodiment of mixing chamber (4).

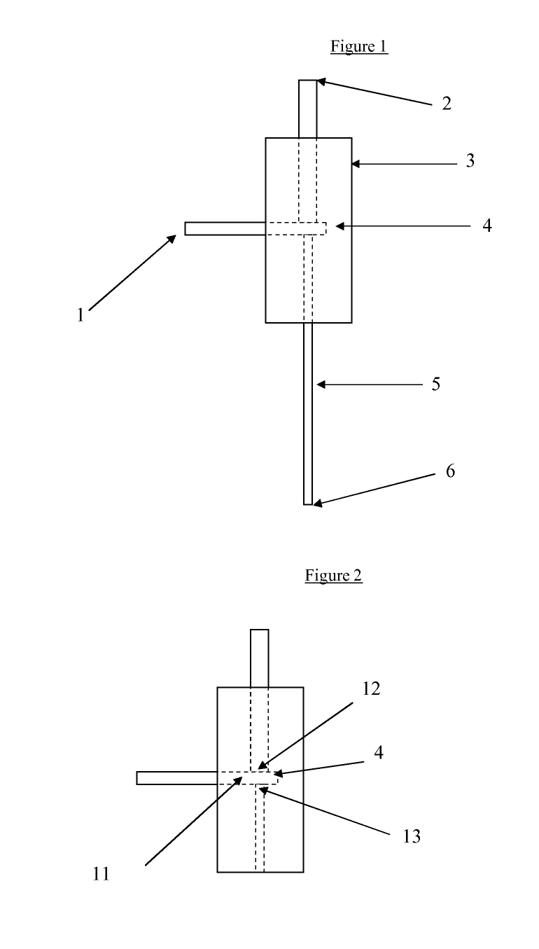

### DESCRIPTION OF PREFERRED EMBODIMENTS

The invention will now be better understood owing to the following explanations and to the exemplary embodiments below.

The cutting process according to the invention consists in using a cutting jet formed, on the one hand, of a cryogenic fluid in liquid form, in particular liquid nitrogen, at UHP, that is to say typically more than 100 bar, or even more than 1000 bar, and, on the other hand, abrasive particles formed from one or more materials having a hardness index of at least 6 Mohs, in order to cut a material.

The abrasive particles are conveyed by a stream of gas, such as air, to the mixing chamber supplying the focusing gun that is used to distribute the jet of liquid nitrogen/abrasive mixture.

The abrasives used in association with the UHP liquid nitrogen are preferably corundum, garnet and olivine for the reasons explained below.

However, other abrasives, such as tungsten carbide, silicon carbide, alumina and calcium carbonate may also be used, depending on the application in question, in particular on the nature or thickness of the material to be cut, on the type of gun used, on the nature of the material forming the mixing chamber, etc.

The performance of an abrasive depends on its particle size, on its shape and on its hardness. Cutting tests were carried out with abrasives having a particle size equal to 80 mesh, i.e. 150 to 180 μm, and having the same shape grains (approximately 60° sharp angles).

It is therefore the hardness of the abrasives which here determines their effectiveness. The hardness indices of several materials are given in Table I below.

TABLE I

| Material | Hardness index (Mohs) |
|---|---|
| Diamond | 10 |
| Cubic boron nitride | 9.8 |
| Boron carbide (B₄C) | 9.5 |
| Silicon carbide | 9.3 |
| Alumina | 9.2 |
| Chromium | 9 |
| Corundum | 9 |
| Standard tungsten carbide (WC) | 8.5 |
| Stainless steel | <8.5 |
| Garnet | 7.5 |
| Olivine | 6.5 |

As seen in this Table I, according to the (Mohs) hardness scale, corundum is better performing than garnet which is itself better performing that olivine since corundum is, amongst other things, the hardest of these three compounds.

However, it was observed that with corundum, the focusing gun, made of standard tungsten carbide (WC) and, to a lesser extent, the mixing chamber, made of hardened steel, experience greater erosion than with garnet. In fact, these degradations are explained by the fact that the hardness of corundum is greater than that of the hardened steel and that of standard tungsten carbide.

Table II below thus illustrates the degradation of a focusing gun as a function of the material constituting said gun, during tests carried out with a mixture of liquid nitrogen and corundum.

TABLE II
After testing for 1 hour: corundum + liquid nitrogen

| | | | | | |
|---|---|---|---|---|---|
| Type of | Standard | WC + | WC + | Alumina | B₄C |
| focusing | WC | abrasion | abrasion | | (Tetrabor ®) |
| gun | | resistant | resistant | | |
| | | (Roctec ® | (Ultramant | | |
| | | 500) | 3000) | | |
| Brand | / | KMT | Ceratizit | Sceram | ESK |
| Results | Inoperative | No loss of | No loss of | Inoperative | No loss of |
| | after | effectiveness | effectiveness | after | effectiveness |
| | 2 min | | | 15 min | |
| Internal | 1.02 mm | 1.02 mm | 1.02 mm | 1.20 mm | 1.20 mm |
| diameter | | | | | |
| before | | | | | |
| use | | | | | |
| Internal | Between | 1.04 mm | 1.08 mm | 3 to 4 mm | 1.20 mm |
| diameter | 2 and | | | | |
| after use | 2.5 mm | | | | |
| Compatibility | Poor | Very good | Very good | Poor | Excellent |
| with | | | | | |
| corundum | | | | | |

It is observed that the Roctec® 500 and Ultramant 3000 focusing guns are harder than the standard tungsten carbide (WC) gun and withstand erosion by corundum much better.

This is due to the proportion of cobalt present in the binder of the tungsten used for manufacturing the guns. Indeed, the lower the amount of cobalt (Co) binder of the tungsten, the more the tungsten is resistant to abrasion but also sensitive to impacts.

However, given that a focusing gun is not subjected to impacts but simply an erosion by friction, it is preferred to use focusing guns formed of tungsten comprising less than 0.5% by weight of cobalt, preferably less than 0.30%, for example of the order of 0.25%, when corundum is chosen as the abrasive material mixed with the stream of liquid nitrogen.

As already mentioned, the mixing chamber 4 is highly eroded by the stream of abrasive particles.

Thus, Table III below shows the degradation of a mixing chamber made of hardened steel following use of a mixture of liquid nitrogen and corundum over 8 hours, in particular of the part 11 of the mixing chamber where the abrasive enters, of the part 12 of the mixing chamber where the liquid nitrogen enters and of the part of the mixing chamber where the nitrogen/abrasive mixture exits, as illustrated in FIG. 2.

TABLE III
After testing for 8 hours: corundum + liquid nitrogen
Hardened steel focusing chamber (cf. FIG. 2)

| | Mixing chamber | | |
|---|---|---|---|
| Internal diameter | Part 11 | Part 12 | Part 13 |
| before use | 3 mm | 2 mm | 4.5 mm |
| after use | 3.1 mm | 4.2 mm | 6.5 mm |

The results obtained show that, despite a significant erosion of its diameter, in particular of parts 12 and 13 from FIG. 2, the stainless steel mixing chamber 4 has remained effective for producing the corundum/liquid nitrogen mixture over the 8 h of testing.

Nevertheless, in order to minimize the wear of the mixing chamber and of the focusing gun, use will be made of a focusing gun, or even also a mixing chamber, which is formed (i.e. bulk parts or surface coatings) from a material harder than the abrasive particles used, in particular harder than corundum, thus making it possible to overcome the problem of erosion due to these abrasive particles, in particular corundum.

Thus, the material of the focusing gun, or even also of the mixing chamber, may be tungsten carbide containing a low content of cobalt (<0.5%), silicon carbide, boron carbide, titanium carbide or other carbide, cubic boron nitride, diamond or any compatible material that is harder than corundum.

In any case, within the context of the invention, it is essential that at least the focusing gun of the jet is made from a material that is resistant to the erosion caused by the abrasive particles since it is the gun which is subjected to the greatest erosion.

Although less high-performance than garnet, olivine may also be used, as demonstrated by supplementary tests carried out under the same conditions as the preceding tests.

Finally, these tests show that using suitable tools makes it possible to increase the service life despite the use of abrasives that are effective for cutting but are highly eroding for the equipment, such as corundum.

This is even more important for applications where the number of preventative and/or corrective maintenance operations should be reduced as much as possible, for example in applications where human intervention is difficult, typically in radioactive environments.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

1-11. (canceled)

12. A process for cutting a material, comprising the step of cutting said material with a cutting jet at a pressure of at least 100 bar, wherein the cutting jet is:
formed by a step of mixing at least a first compound in liquid form and at a cryogenic temperature of less than −100° C., and a gas stream comprising solid abrasive particles formed from at least one abrasive material having a hardness index of at least 6 Mohs, wherein said solid abrasive particles comprise at least one abrasive material chosen from corundum, garnet, tungsten carbide, silicon carbide, titanium carbide, olivine, alumina or calcium carbonate; and
the cutting jet is directed toward the material to be cut by a focusing gun comprising a focusing gun material having a hardness greater than the hardness of the solid abrasive particles used, and said focusing gun material chosen from tungsten carbide with a cobalt content between around 0.1 and 10%, silicon carbide, titanium carbide, boron carbide, cubic boron nitride or diamond.

13. The process as claimed in claim 12, wherein the pressure of the cutting jet is between 500 and 4000 bar.

14. The process of claim 12, wherein the compound in liquid form is at a temperature of less than −150° C.

15. The process of claim 12, wherein the first compound is liquid nitrogen.

16. The process of claim 12, wherein the material cut is made of metal, of ceramic, of concrete, of wood, of plastic or of polymer.

17. The process of claim 12, wherein the gas stream comprising the solid abrasive particles is an air stream.

18. The process of claim 12, wherein the mixing of the first compound in liquid form and the gas stream comprising solid abrasive particles takes place in a mixing chamber comprising hardened steel, tungsten carbide with a cobalt content between around 0.1 and 10%, silicon carbide, titanium carbide, cubic boron carbide, boron nitride or diamond.

19. The process of claim 18, wherein the mixing chamber has a hardness greater than the hardness of the abrasive used.

20. The process of claim 12, wherein the solid abrasive particles comprise at least one abrasive material chosen from corundum, garnet and olivine.

21. The process of claim 20, wherein the abrasive material is corundum.

22. A device for cutting using a cutting jet at a pressure of at least 100 bar comprising a source of pressurized cryogenic liquid fluidly connected to a mixing chamber (4) and adapted to supply the pressurized cryogenic liquid to said mixing chamber (4), and a focusing gun (5) fluidly connected to said mixing chamber (4), wherein the device further comprises a source of abrasive particles having a hardness index of at least 6 Mohs, adapted to supply the abrasive particles to the mixing chamber (4) whereby the device is configured to be capable of supplying the focusing gun (5) with a mixture formed of at least the pressurized cryogenic liquid and said abrasive particles, wherein the focusing gun (5) is configured to emit the mixture in the form of a cutting jet, the focusing gun (5) comprising tungsten carbide with a cobalt content between around 0.1 and 10%, silicon carbide, titanium carbide, of boron carbide, cubic boron nitride or diamond.

23. The device as claimed in claim 22, wherein the mixing chamber (4) comprises hardened steel, tungsten carbide with a cobalt content between around 0.1 and 10%, silicon carbide, titanium carbide, boron carbide, cubic boron nitride or diamond.

24. The device of claim 22, wherein the focusing gun (5) or the mixing chamber (4) comprises tungsten carbide comprising a cobalt content between around 0.1 and 10%, the tungsten carbide comprising grains having a size of less than 1.5 μm.
